(19) United States
(12) Patent Application Publication
(10) Pub. No.: US 2026/0117935 A1
(43) Pub. Date: Apr. 30, 2026

(54) SYSTEM, METHOD, AND CANISTER FOR RELEASING FILTERED VAPOR DURING AN OVERPRESSURE EVENT FOR OXIDATION STABILITY OF TRANSPORTATION FUELS

(71) Applicant: Marathon Petroleum Company LP, Findlay, OH (US)

(72) Inventors: Tayler M. Justice, Findlay, OH (US); John J. Langenfeld, Findlay, OH (US); Alex M. Markins, Findlay, OH (US); Kevin P. Richards, Findlay, OH (US)

(73) Assignee: Marathon Petroleum Company LP, Findlay, OH (US)

(21) Appl. No.: 19/374,798

(22) Filed: Oct. 30, 2025

Related U.S. Application Data
(60) Provisional application No. 63/714,613, filed on Oct. 31, 2024.

(51) Int. Cl. F17C 13/12

(52) U.S. Cl. CPC F17C 13/12; F17C 2205/0314; F17C 2221/032; F17C 2265/012

(57) ABSTRACT

Embodiments of systems, methods, and canisters to filter flammable vapor and release filtered vapor during an overpressure event are disclosed. An embodiment of a method may include flowing a fluid from a sample vessel to a pressure relief device. The fluid may include one or more liquids and one or more flammable gases. The method may include flowing the fluid from the pressure relief device to a pressure flow reducer cylinder when the overpressure event occurs, reducing the pressure flow of the fluid in the pressure flow reducer cylinder, and flowing the reduced pressure flow fluid from the pressure flow reducer cylinder to a canister. The method also may include adsorbing vapors of the one or more flammable gases of the fluid when present in the reduced pressure flow fluid in the canister, thereby to obtain filtered vapor, and releasing the filtered vapor from the canister.

### CROSS-REFERENCE TO RELATED APPLICATIONS

This application claims priority to and the benefit of U.S. Provisional Patent Application No. 63/714,613, filed October 31, 2024, which is incorporated by reference in its entirety.

### FIELD OF DISCLOSURE

This disclosure relates to systems, methods, and structures associated with the adsorption of gases generated during production and testing of transportation fuels.

### BACKGROUND

There are a large number of specifications and related test methods for petroleum products due to the commercial, environmental, quality, production, and processing aspects of such products. The American Society for Testing and Materials (ASTM) develops internationally recognized standards used in areas such as metals, paints, plastics, textiles, petroleum, construction, energy, the environment, consumer products, medical services, devices and electronics, and advanced materials, among others. The ASTM has several standards for testing the performance of petroleum products including transportation fuels.

For example, the ASTM D525 Standard Test Method is used to determine the oxidation stability of transportation fuels, such as gasoline. An ASTM D525 system, for example, generally includes a sample vessel, connecting pipes, pressure relief device, various thermometers, pressure gages, and a gas outlet. In the ASTM D525 Standard Test Method, a gasoline sample is oxidized in a pressure vessel initially filled at a temperature ranging from 15°C to 25°C with oxygen at a pressure ranging from 690 kPa to 705 kPa, and heated at a temperature between 98°C and 102°C. The pressure is recorded continuously or read at specific intervals until a breakpoint is reached. The time required for the sample to reach this point is the observed induction period at the temperature of the test, from which the induction period at 100°C can be calculated. The induction period may be used as an indication of the tendency of the gasoline to form gum in storage.

During the ASTM D525 Standard Test Method, for example, if pressure inside the sample vessel reaches greater than 1530 kPa +10%, a pressure relief device will rupture. The autoignition

of gasoline samples upon rapid release through the pressure relief device can occur. This is due to the sample vessel containing gasoline and being pressurized with oxygen. In the event of an unplanned discharge through the pressure relief device, gasoline vapors are released to atmosphere with undesired autoignition potential. As gasoline vapors are highly flammable, a risk of their unplanned release into the atmosphere may result in explosion, which may be hazardous to operators of the system.

### SUMMARY

Thus, in view of the foregoing, Applicant has recognized these problems and others in the art, and has recognized a need for embodiments of systems, methods, and canisters for filtering flammable vapors, and releasing filtered vapor during an overpressure event during the standard test method for oxidative stability of transportation fuels, which will prevent the release of flammable vapors, and subsequently prevent unplanned explosions.

The disclosure herein provides embodiments of systems and methods of filtering flammable vapors or releasing filtered vapor during an overpressure event during oxidation testing of transportation fuels to prevent the autoignition of flammable vapors, adding an additional feature to lower risk for operators of the oxidative testing system.

Some embodiments of such systems and methods may include flowing a fluid including one or more flammable vapors from a sample vessel to a pressure relief device in the testing system when the overpressure event occurs. The overpressure event may occur in the sample vessel when the pressure inside the vessel reaches a specific pressure, for example to a pressure greater than 1530 kPa ±10 %, causing the pressure relief device to activate or rupture. Embodiments of a pressure relief device, for example, may include a rupture disc or a burst-disc assembly. The pressure relief device may be stainless steel in some embodiments. As will be understood by those skilled in the art, the fluid in some embodiments may include transportation fuels such as gasoline, and the flammable vapors may include gasoline vapors such as hydrocarbons and aromatic compounds.

Upon activation or rupture of the pressure relief device, the fluid may flow from the pressure relief device through a first tube to a pressure flow reducer cylinder. The pressure flow reducer cylinder may be a single-ended cylinder or a double-ended cylinder and may be a double-ended cylinder. The pressure flow reducer cylinder may have a stainless steel body in order to resist corrosion and may be lined with a polymer material coating. The internal volume of the pressure flow reducer cylinder may range from about 150 cm³ to about 500 cm³. The pressure and temperature of the fluid may be measured using various thermometers and gages, as will be understood by those skilled in the art, while the fluid flows from the pressure relief device to through the first tube. Once the fluid reaches the pressure flow reducer cylinder, the pressure flow of the fluid is reduced. In some embodiments, for example, the pressure flow of the fluid may be reduced by at least 300%, or one-third.

Once the pressure flow of the fluid is reduced, some embodiments of the systems or methods may flow the reduced pressure fluid from the pressure flow reducer cylinder to a canister, e.g., a carbon canister, through a second tube. The opening of the carbon canister, for example, can be orientated in a vertical or upright position. The reduced pressure flow fluid may be collected within the canister. Inside the carbon canister, the flammable vapors present in the fluid are adsorbed to filter out the flammable vapor. The filtered vapor may be released to the atmosphere from the testing system. By filtering out the flammable vapor, this reduces the risk of a fire or other hazard when an overpressure event occurs.

Embodiments of canisters also are included in the disclosure. An embodiment of a canister, for example, may have a housing with an interior and an exterior. The canister may be composed of corrosion-resistant stainless steel. A filter material such as an absorbent material or an adsorbent material, e.g., activated carbon, may be present in the interior of the housing. The canister is open to an atmosphere in order to release the filtered vapors. As noted, the adsorbent material may include activated carbon, activated charcoal, or another absorbent material as will be understood by those skilled in the ar. If the adsorbent material is activated carbon, for example, it may be large-chunk activated carbon. The adsorbent material may be replaceable inside the canister.

Accordingly, an embodiment of the disclosure also is directed to a method of releasing filtered vapor, filtering flammable vapor, or mitigating the release of flammable vapor during an overpressure event. The method may include flowing a fluid from a sample vessel to a pressure relief device through a vent line connected to the sample vessel. The fluid may include one or more liquids and one or more flammable gases. The method also may include flowing the fluid from the pressure relief device through a first tube, thereby to a pressure flow reducer cylinder when the overpressure event occurs, measuring a pressure flow of the fluid when flowing through the first tube, reducing the pressure flow of the fluid in the pressure flow reducer cylinder, and flowing the reduced pressure flow fluid from the pressure flow reducer cylinder to a carbon canister through a second tube, thereby to collect the reduced pressure flow fluid within the carbon canister. The method further may include adsorbing vapors of the one or more flammable gases of the fluid when present in the reduced pressure flow fluid in the carbon canister, thereby to obtain filtered vapor, and releasing the filtered vapor from the carbon canister into atmosphere.

In an embodiment of a method, the method still further may include flowing the fluid through a charge line and to a sample vessel connected to the charge line prior to flowing the fluid from the sample vessel to a pressure relief device, and collecting the reduced pressure flow fluid within the carbon canister so that vapors of the one or more flammable gas are absorbed therein. In some embodiments, for example, the pressure flow of the fluid flowing from the pressure relief device may be reduced in the pressure flow reducer cylinder by at least 300%.

Another embodiment of the disclosure is directed to a system for releasing filtered vapor, filtering flammable vapors, or mitigating the release of flammable vapors during an overpressure event. The system may include a sample vessel connected to a pressure relief device by a vent line. The sample vessel may be configured to test the stability of fluid having one or more flammable vapors. The pressure relief device may be configured to operate during an overpressure event. The system may include a pressure flow reducer cylinder connected to the pressure relief device by a first tube. The pressure flow reducer cylinder may be configured to operate during an overpressure event to reduce the pressure flow of the fluid. The system may include a canister connected to the pressure relief device by a second tube. The canister may be configured to filter the one or more flammable vapors present in the fluid. In some embodiments, the canister includes an adsorbent material, which may be activated carbon or activated charcoal, and may include large-chunk activated carbon.

### BRIEF DESCRIPTION OF DRAWINGS

Still other aspects and advantages of these embodiments and other embodiments, are discussed in detail herein. Moreover, it is to be understood that both the foregoing information and the following detailed description provide merely illustrative examples of various aspects and embodiments and are intended to provide an overview or framework for understanding the nature and character of the claimed aspects and embodiments. Accordingly, these and other objects, along with advantages and features herein disclosed, will become apparent through reference to the following description and the accompanying drawings. Furthermore, it is to be understood that the features of the various embodiments described herein are not mutually exclusive and may exist in various combinations and permutations.

These and other features, aspects, and advantages of the disclosure will become better understood with regard to the following descriptions, claims, and accompanying drawings. It is to be noted, however, that the drawings illustrate only several embodiments of the disclosure, and therefore, these disclosed embodiments are not to be considered limiting of the disclosure’s scope.

FIG. 1 is a schematic diagram of a system in which a canister containing activated carbon is present downstream of a pressure flow reducer cylinder in an ASTM D525 Standard Test Method arrangement according to an embodiment of the disclosure.

FIG. 2 is a schematic diagram of an embodiment of a canister containing activated carbon according to an embodiment of the disclosure.

FIG. 3 is a sectional view of the canister of FIG. 2 containing activated carbon according to an embodiment of the disclosure.

FIG. 4 is a schematic block diagram of a method of releasing filtered vapor during an overpressure event according to an embodiment of the disclosure.

### DETAILED DESCRIPTION

So that the manner in which the features and advantages of the embodiments of the systems and methods disclosed herein, as well as others, which will become apparent, may be understood in more detail, a more particular description of embodiments of systems and methods briefly summarized above may be had by reference to the following detailed description of embodiments thereof, in which one or more are further illustrated in the appended drawings, which form a part of this specification. However, it is to be noted that the drawings illustrate only various embodiments of the systems and methods disclosed herein and, therefore, are not to be considered limiting of the scope of the systems and methods disclosed herein as it may include other effective embodiments as well.

The manufacture and processing of transportation fuels requires adherence to numerous standards. One such standard is a risk of the potential for gum formation, or build-up, of the transportation fuel while the transportation fuel is stored. Gum may be formed as a byproduct of unstable fuel components, and the presence of gum in fuel increases continuously during storage, resulting in a decline in oil quality. The oxidation stability of transportation fuels is measured as a way to determine a transportation fuels susceptibility for forming gums.

Testing the oxidative stability of transportation fuels involves the pressurization of a sample of the transportation fuel using oxygen in a specialized system. In general, this testing involves a pressurization of the transportation fuel sample using oxygen inside a specialized pressurization vessel. In some cases, this may result in or otherwise risks the autoignition of the gasoline sample upon rapid release through a pressure relief device. This is due to the pressure vessel containing gasoline being pressurized with oxygen. In the event of an unplanned discharge through the pressure relief device, gasoline vapors are released to atmosphere with undesired autoignition potential. As gasoline vapors are highly flammable, their unplanned release into the atmosphere risks resulting in an explosion, which presents a hazard to operators of the testing system. Examples of such methods for testing the oxidative stability of transportation fuels includes the ASTM D525 Standard Test Method as will be understood by those skilled in the art.

Thus, in view of the foregoing, Applicant has recognized these problems and others in the art and has recognized a need for enhanced features which can reduce risk of hazardous conditions for or when applying the ASTM D525 Standard Test Method. Provided herein are embodiments of methods of releasing filtered vapor during an overpressure event. Such embodiments of methods, for example, may include flowing a fluid from a sample vessel to a pressure relief device through a vent line connected to the sample vessel. The fluid may include one or more liquids and one or more flammable gas. The fluid may flow from the pressure relief device through a first tube, thereby to a pressure flow reducer cylinder when the overpressure event occurs. A pressure flow of the fluid may be measured when flowing through the first tube. The pressure flow of the fluid may be reduced in the pressure flow reducer cylinder. The reduced pressure flow fluid may flow from the pressure flow reducer cylinder to a carbon canister through a second tube, thereby to collect the reduced pressure flow fluid within the carbon canister. Vapors of the one or more flammable gas of the fluid may be absorbed when present in the reduced pressure flow fluid in the carbon canister to obtain filtered vapor, and the filtered vapor may be released from the carbon canister into atmosphere. This provides safety mitigation for the ASTM D525 system by reducing the risk of undesired autoignition in the event of an unplanned discharge or overpressure event through the pressure relief device and carbon canister.

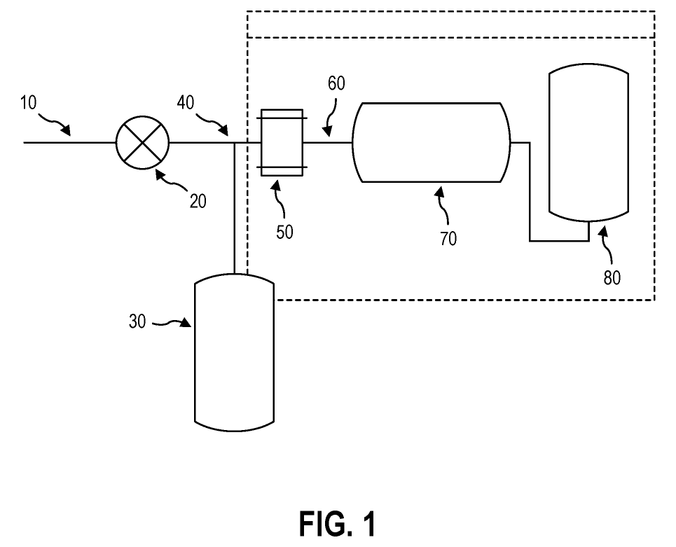

FIG. 1 is a diagram of a system of filtering flammable vapors and releasing filtered vapor during an overpressure event in an ASTM D525 Standard Test Method including the pressure flow reducer cylinder and carbon canister.

In the process of measuring the oxidative stability of transportation fuels using the ASTM D525 Standard Test Method, a charge line 10 and an isolation valve 20 control the flow of a predetermined volume of the transportation fuel to the sample vessel. The sample vessel 30 may contain a pre-determined volume of a transportation fuel to be tested for oxidative stability. The sample is oxidized in a pressure vessel initially filled at 15°C to 25°C with oxygen pressure at 690 kPa to 705 kPa and heated at a temperature between 98°C and 102°C. The pressure is recorded continuously or read at stated intervals until the breakpoint is reached. The time required for the sample to reach this point is the observed induction period at the temperature of test, from which the induction period at 100°C can be calculated.

In some embodiments, the sample vessel may be composed of a corrosion-resistant stainless steel material, for example, and may have a cylindrical shape. The sample vessel may be connected via one or more vent lines 40 to a pressure relief device 50. The one or more vent lines may be composed of a stainless steel material and have a preselected diameter and a preselected length.

The fluid present inside the sample vessel may contain one or more liquids and one or more gases. The liquid may include a transportation fuel such as gasoline. The one or more gases may be a flammable gas, and may include flammable vapors such as gasoline vapors, hydrocarbons, aromatic compounds, sulfur-containing compounds, carbon monoxide, nitrogen oxides, or carbon dioxide.

A pressure relief device may be present downstream from the sample vessel and may be connected to the sample vessel via a vent line. The pressure relief device, for example, in some embodiments may include a rupture disc, pressure safety disc, burst disc, bursting disc, or burst diaphragm. In some embodiments, the pressure relief device is a non-reclosing pressure relief device that, in most uses, protects a pressure vessel, equipment or system from over-pressurization or potentially damaging vacuum conditions. A pressure relief device will trigger if the pressure increases inside a line or vessel, and the valve fails to operate or cannot relieve enough pressure fast enough. The pressure relief device is rated for a specific pressure at which the pressure relief device will engage. For example, one embodiment of a pressure relief device will rupture if subjected to a pressure greater than 1530 kPa ± 10 %.

Downstream from the pressure relief device, a pressure relief device relief line 60 connects the pressure relief device to a pressure flow reducer cylinder 70. An example of the pressure flow reducer cylinder includes cylinders manufactured by Swagelok®. The pressure relief device relief line may be composed of a stainless steel material and have a selected diameter and a selected length.

In some embodiments, for example, the pressure flow reducer cylinder may reduce the pressure or flow of the flowing fluid by at least about 300%, by at least about 325%, by at least about 350%, by at least about 375%, by at least about 400%, by at least about 425%, by at least about 450%, by at least about 475%, by at least about 500%, by at least about 525%, by at least about 550%, by at least about 575%, by at least about 600%, by at least about 625%, by at least about 650%, by at least about 675%, or by at least about 700%. By reducing the pressure and flow of the flowing fluid, the adsorption of flammable vapors may be increased, which prevents the release of the flammable vapors into the atmosphere due to an overpressure event.

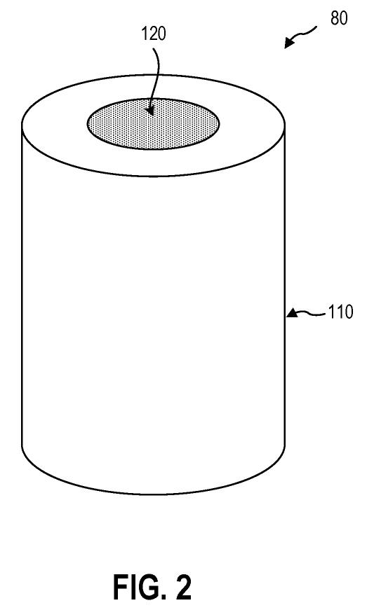

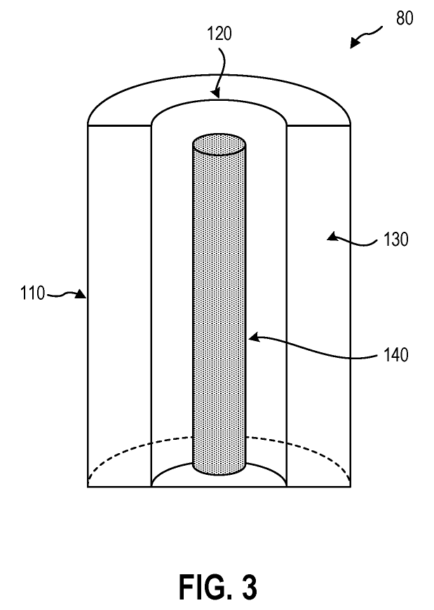

Downstream from the pressure flow reducer cylinder may be a canister 80 containing carbon, which may be referred to as a carbon canister. In an embodiment, the carbon canister 80 is orientated in a vertical configuration. FIGS. 2 and 3 are diagrams of the canister. The canister 80 may be composed of stainless steel, and the cannister 80 may have a cylindrical, or conical shape. The canister 80 may have an exterior 110 and an opening 120 from the exterior to the interior of the canister 80. The carbon present inside the canister may include an adsorbent material 140, such as activated carbon or activated charcoal, as will be understood by those skilled in the art. The adsorbent material may be present in the carbon canister to adsorb flammable vapors. The activated carbon or activated charcoal may include large-chunk activated carbon or activated charcoal. The activated carbon or activated charcoal may be adsorbent and may adsorb flammable vapors. The surface area of the activated carbon or activated charcoal may be approximately or about 1100 m²/g or more, which allows for substantial adsorption of vapors present in the fluid.

The adsorbent material inside the carbon canister may be replaceable such that an operator of the system may replace the adsorbent material after using the system.

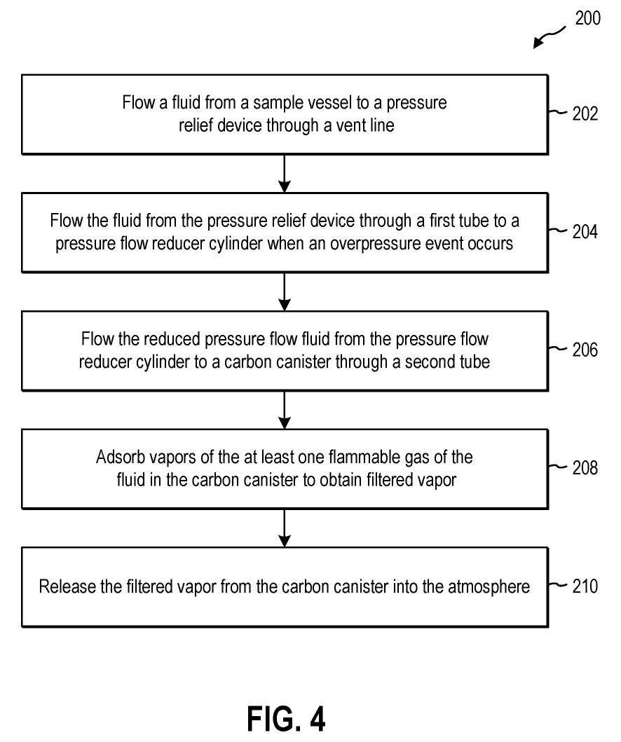

FIG. 4 is a block diagram of a method 200 of releasing filtered vapor during an overpressure event. At block 202, a fluid flows from a sample vessel to a pressure relief device through a vent line when an overpressure event occurs. The fluid may contain one or more gases . The liquid may contain gasoline, and the gas may include flammable vapors. At block 204, the fluid flows from the pressure relief device to a pressure flow reducer cylinder, where, for example, in an embodiment, the flow of the fluid is reduced by at least 300%. At block 206, the reduced pressure flow fluid flows from the pressure flow reducer cylinder to a carbon canister. The carbon canister contains an adsorbent material, which may include activated carbon or activated charcoal. At block 208, the vapors of the one or more flammable gas of the fluid are adsorbed by the adsorbent material present in the carbon canister to obtain filtered vapor. At block 210, the filtered vapor is released from the carbon canister into the atmosphere.

In some embodiments, the flammable vapors may be filtered and released from the ATSM Standard Test Method system if an overpressure event occurs. The fluid present in the sample vessel, which includes the transportation fuel, flows from a sample vessel to a pressure relief device through a vent line connected to the sample vessel. In some embodiments, the pressure relief device, as will be understood by those skilled in the art, may be a rupture disc assembly that will rupture, or burst, at very high-pressure conditions. A rupture disc assembly has an associated relief rating. As an example, one such rupture disc assembly will rupture at the pressure of 1530 kPa +10%. An example of the rupture disc assembly includes burst discs manufactured by Koehler Instrument Company, Inc.®.

In some embodiments, the fluid also may include one or more liquids and one or more flammable gases which may include hydrocarbons, aromatic compounds, sulfur-containing compounds, carbon monoxide, nitrogen oxides, or carbon dioxide.

In order to capture or sequester the flammable gases present in the fluid to reduce the risk of or otherwise prevent explosion, in some embodiments it may be desirable or necessary to decrease the flow of the fluid through the system prior to the flammable gasses exiting the system. When the overpressure event occurs, the fluid flows from the pressure relief device through a first tube to a pressure flow reducer cylinder, where the pressure of the flow will be reduced. The pressure flow and temperature of the fluid may be measured using various thermometer and meters when the fluid flows through the first tube. Once the fluid reaches the pressure flow reducer cylinder. The pressure flow of the fluid is reduced in the pressure flow reducer cylinder to obtain a reduced pressure flow fluid.

In some embodiments, the pressure flow reducer cylinder may reduce the pressure or flow of the fluid by at least about 300%, by at least about 325%, by at least about 350%, by at least about 375%, by at least about 400%, by at least about 425%, by at least about 450%, by at least about 475%, or by at least about 500%, by at least about 525%, by at least about 550%, by at least about 575%, by at least about 600%, by at least about 625%, by at least about 650%, by at least about 675%, or by at least about 700%.

As an example, the ASTM D525 system may have a total volume of about 303 cm³, excluding any sample gasoline being tested. The initial pressure of the gas present in the system may be about 100psi. Upon an overpressure event, the pressure may be reduced from about 100 psi to about 50 psi, and further to about 33 psi.

In some embodiments, the reduced pressure flow fluid will flow through a second tube from the pressure flow reducer cylinder to a canister having absorbent material positioned inside the canister. The reduced pressure flow fluid will accumulate inside the canister. The canister may have a housing having an interior, an exterior, and an opening from the interior to the atmosphere. An example of the carbon canister includes carbon canister manufactured by United Filtration Systems, Inc. In other words, the canister may be open to the atmosphere, which allows vapors or gas to be released from the canister. The canister in some embodiments, for example, may have a length ranging from about 200 mm to about 300 mm, and a width ranging from about 50 mm to 150 mm. Embodiments of the canister also include an adsorbent material present in the interior of the housing. The adsorbent material includes one or more of activated carbon or activated charcoal. If the adsorbent material is activated carbon, the absorbent material may be large-chunk activated carbon.

The adsorbent material inside the canister may line the walls of the interior of the canister, may be loosely contained in the interior of the canister, or may be present on a scaffold inside the canister. For example, the adsorbent material may be present inside an adsorption column, in which loose adsorbent material fills the adsorption column. The amount of the adsorbent material present in the carbon canister may range from about 500 cm³ to about 1000 cm³, and may be, for example, about 800 cm³.

Over time, the adsorption ability of the activated carbon may decrease with use. Therefore, it may be desirable to replace the adsorbent material inside the canister. Therefore, in some embodiments, the adsorbent material present inside the canister may be replaceable, or capable of being removed from the canister and replaced with adsorbent material. For example, after exhaustion, the loose adsorbent material present inside an adsorption column may be removed from the column and replaced with new adsorbent material.

The flammable vapors are selectively adsorbed when the reduced pressure flow fluid is present in, or flowing through, the canister. The resulting vapors obtained are filtered vapors. Only filter vapor is released from inside the canister into atmosphere. This prevents or mitigates fire hazards in the testing system if an overpressure occurs.

In some embodiments, a system may be provided for filtering flammable gas or releasing filtered vapor from the ATSM Standard Test Method system if an overpressure event occurs. The system includes a sample vessel connected to a pressure relief device by a vent line. The sample vessel is capable of containing a specified volume of a transportation fuel to be tested in the system. The sample vessel is pressurized during testing. The pressure inside the sample vessel is monitored to ensure safety of the operators of the testing system.

The sample vessel configured to test the stability of fluid comprising one or more flammable vapors. The fluid may include one or more liquids and one or more flammable gases which may include hydrocarbons, aromatic compounds, sulfur-containing compounds, carbon monoxide, nitrogen oxides, or carbon dioxide.

The pressure relief device may be triggered when the pressure inside the sample vessel reaches a critical point. The pressure relief device is a rupture disc assembly that will burst if the pressure inside the sample vessel peaks.

A pressure flow reducer cylinder may be connected downstream from the pressure relief device by a first tube. The pressure flow reducer cylinder may be configured to operate during an overpressure event. The pressure flow of the fluid may be reduced when the fluid reaches the pressure flow reducer cylinder.

In some embodiments, the pressure flow reducer cylinder may reduce the pressure or flow of the fluid by at least about 300%, by at least about 325%, by at least about 350%, by at least about 375%, by at least about 400%, by at least about 425%, by at least about 450%, by at least about 475%, or by at least about 500%, by at least about 525%, by at least about 550%, by at least about 575%, by at least about 600%, by at least about 625%, by at least about 650%, by at least about 675%, or by at least about 700%.

In embodiments, a canister also may be connected to the pressure relief device. The canister filters the one or more flammable vapors present in the fluid via an adsorbent material present inside the canister.

The canister may have a housing having an interior, an exterior, and an opening from the interior to the atmosphere. In other words, the canister may be open to the atmosphere, which allows vapors or gas to be released from the canister. The canister also includes an adsorbent material present in the interior of the housing. The adsorbent material includes one or more of activated carbon or activated charcoal. If the adsorbent material is activated carbon, then the absorbent material, in some embodiments, may be large-chunk activated carbon.

The adsorbent material inside the canister may line the walls of the interior of the canister, may be loosely contained in the interior of the canister, or may be present on a scaffold inside the canister, as will be understood by those skilled in the art.

Over time, the adsorption ability of the activated carbon may decrease with use. Therefore, it may be desirable to replace the adsorbent material inside the canister. Therefore, in some embodiments, the adsorbent material present inside the canister may be replaceable, or capable of being removed from the canister and replaced with adsorbent material.

Although specific terms are employed herein, the terms are used in a descriptive sense only and not for purposes of limitation. Embodiments of systems, methods, and canisters have been described in considerable detail with specific reference to the illustrated embodiments. However, it will be apparent that various modifications and changes can be made within the spirit and scope of the embodiments of systems, methods, and canisters as described in the foregoing specification, and such modifications and changes are to be considered equivalents and part of this disclosure.

What is claimed is:

1. A system for releasing filtered vapor during an overpressure event, the system comprising:
a sample vessel connected to a pressure relief device by a vent line, the sample vessel configured to test stability of fluid comprising a flammable vapor, and the pressure relief device configured to operate during an overpressure event;
a pressure flow reducer cylinder connected to the pressure relief device, the pressure flow reducer cylinder also configured to operate during an overpressure event, thereby to reduce the pressure flow of the fluid; and
a canister connected to the pressure flow reducer cylinder and configured to filter the flammable vapor present in the fluid, the canister including a filter material positioned therein.

2. The system of claim 1, wherein the pressure of the fluid flowing from the pressure relief device is reduced in the pressure flow reducer cylinder by at least one third.

3. The system of claim 1, wherein the filter material comprises one or more of activated carbon or activated charcoal.

4. The system of claim 1, wherein the filter material comprises large-chunk activated carbon.

5. The system of claim 1, wherein the canister includes an opening to the atmosphere.

6. The system of claim 1, wherein the filter material is replaceable within the canister.

7. A method of mitigating release of flammable vapor during an overpressure event, the method comprising:
flowing a fluid including a flammable vapor from a sample vessel to a pressure relief device;
flowing the fluid from the pressure relief device to a pressure flow reducer cylinder;
reducing the pressure flow of the fluid in the pressure flow reducer cylinder;
flowing the reduced pressure flow fluid from the pressure flow reducer cylinder to a canister;
filtering the flammable vapor from the fluid in the canister; and
releasing the filtered fluid from the canister into atmosphere.

8. The method of claim 7, further comprising flowing the fluid through a charge line and to a sample vessel connected to the charge line prior to flowing the fluid from the sample vessel to a pressure relief device.

9. The method of claim 7, wherein filtering the flammable vapor from the fluid in the canister includes adsorbing the flammable vapor from the fluid.

10. The method of claim 7, wherein the pressure of the fluid flowing from the pressure relief device is reduced in the pressure flow reducer cylinder by at least one third.

11. The method of claim 7, wherein the canister comprises a container housing and a filter material positioned therein.

12. The method of claim 11, wherein the canister comprises an opening connected to the atmosphere.

13. The method of claim 11, wherein the pressure relief device comprises a rupture disc, and wherein the filter material comprises activated carbon.

14. The method of claim 13, wherein the filter material comprises large-chunk activated carbon.

15. The method of claim 11, further comprising moving the filter material after usage from the canister and replacing the filter material within the canister with unused filter material.

16. The method of claim 11, wherein a surface area of the filter material is at least 1100 m²/g.

17. The method of claim 7, further comprising measuring a pressure flow of the fluid while flowing to the pressure flow reducer cylinder.

18. The method of claim 7, wherein flowing the fluid including the flammable vapor from a sample vessel to a pressure relief device includes flowing a fluid from a sample vessel to a pressure relief device through a vent line connected to the sample vessel.

19. The method of claim 7, wherein flowing the fluid from the pressure relief device to a pressure flow reducer cylinder includes flowing the fluid from the pressure relief device through a first tube and to a pressure flow reducer cylinder.

20. The method of claim 7, wherein filtering the flammable vapor in the canister includes adsorbing the flammable vapor from the fluid in the reduced pressure flow fluid in the canister.
